(19) United States
(12) Patent Application Publication
(10) Pub. No.: US 2016/0121642 A1
(43) Pub. Date: May 5, 2016

(54) Storage Component with Pivotable Pocket

(71) Applicant: ACCO Brands Corporation, Lake Zurich, IL (US)

(72) Inventor: Scot B. Herbst, Santa Cruz, CA (US)

(21) Appl. No.: 14/932,323

(22) Filed: Nov. 4, 2015

Related U.S. Application Data
(60) Provisional application No. 62/074,812, filed on Nov. 4, 2014.

(51) Int. Cl. B42F 13/00; B42F 13/16

(52) U.S. Cl. CPC B42F 13/0033; B42F 13/16

(57) ABSTRACT

A storage component including an outer casing having a first panel and a second panel pivotally coupled together. The storage component further includes a pocket panel directly pivotally coupled to the outer casing and a pocket positioned on the pocket panel. The pocket is pivotable relative to the outer casing and positionable internally to the outer casing.

This application claims priority to U.S. Provisional Patent Application Ser. No. 62/074,812, filed on Nov. 4, 2014, the entire contents of which are hereby incorporated by reference.

### BACKGROUND

Binders are typically used in home, office and school settings to provide portable storage devices for holding various contents. The binders can be configured to store notebooks, papers, pencil/pen pouches or the like. Such binders may also incorporate various pockets, but in some cases the pockets can be of limited utility.

### SUMMARY

In one embodiment, the present invention is a binder including a pivotable pocket. In particular, in one embodiment the invention is a storage component including an outer casing having a first panel and a second panel pivotally coupled together. The storage component further includes a pocket panel directly pivotally coupled to the outer casing and a pocket positioned on the pocket panel. The pocket is pivotable relative to the outer casing and positionable internally to the outer casing.

### BRIEF DESCRIPTION OF THE DRAWINGS

FIG. 1 is a front perspective view of one embodiment of the binder of the present invention, shown in its closed position;

FIG. 2 is a front perspective view of the binder of FIG. 1 in an open position, and with the pocket positioned adjacent a front cover of the binder, and with a piece of paper bound to the binding mechanism;

FIG. 3 is a front perspective view of the binder of FIG. 2, with the pocket in a vertical configuration;

FIG. 4 is a front perspective view of the binder of FIG. 3, with the pocket positioned adjacent a back cover of the binder; and

FIG. 5 is a front perspective view of an alternative embodiment of the binder, shown in its open position with the pocket in a vertical configuration.

### DETAILED DESCRIPTION

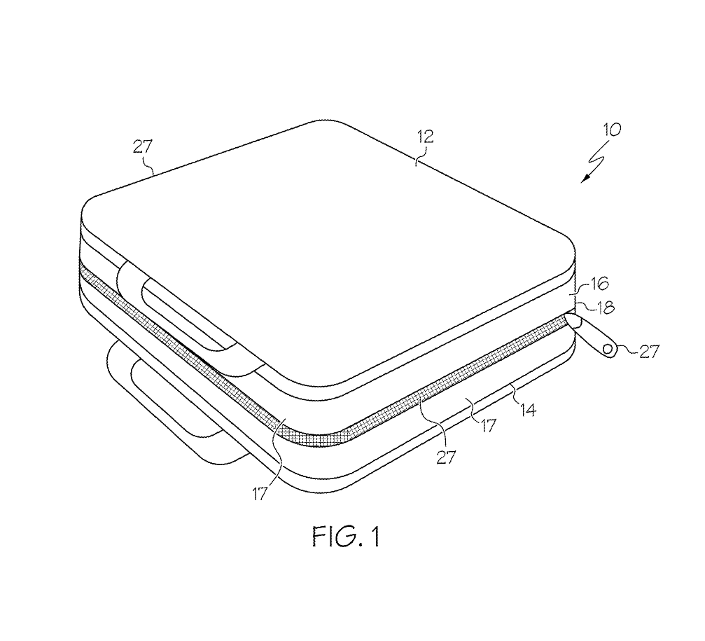

As shown in FIGS. 1-4, in one embodiment a binder or bound component, generally designated 10, may include an outer cover or casing 12 having a first or front cover or panel 14 pivotally coupled to a second or back cover or panel 16, about a hinge area/line/spine/third panel 18 positioned therebetween. The hinge line/spine 18 may define a hinge axis about which the covers 14, 16 can fold/pivot. Alternatively, each cover 14, 16 can be coupled to the spine 18 along its own hinge/fold line.

The bound component 10 may also include a binding mechanism 22. In the illustrated embodiment the binding mechanism 22 is coupled to an inner surface of the back cover 16, although the binding mechanism 22 could be coupled to any inner surface of the outer casing 12, including the front cover 14 and/or spine 18. The binding mechanism 22 may be located relatively close to the hinge line/spine 18 in a lateral direction; i.e. in a direction perpendicular to the hinge line/spine 18. In one case, for example, the entire binding mechanism 22 is positioned no further from the hinge line/spine 18 in the lateral direction than about 25% of a dimension of the associated front 14 or back 16 cover in the lateral direction (e.g. in one case the entire binding mechanism 22 is positioned in the inner 25% of the front 14 or back 16 cover in the lateral direction).

In the illustrated embodiment the binding mechanism 22 takes the form of a three-ring binder or the like, including one or more binding rings 24. Each binding ring 24 may be separable into two separate ring halves or portions such that papers 23 or other items can be placed into, or removed from, the binding mechanism 22. Each binding ring 24 may also be movable to a closed position in which the ring halves engage each other and form a closed ring to trap the bound contents therein.

The binding mechanism 22 may include one or more actuators 26 that are manually operable to move the binding rings 24 between the open and closed position. However, the binding mechanism 22 can take any of a variety of other forms or configurations besides ring binding mechanisms, and can include or take the form of a coil or wire binding (including spiral and twin-wire bindings), clamps, clips, cords, ribbons, elastic connectors, adhesives, book-style bindings, and combinations thereof, depending upon manufacturing preferences. The binding mechanism 22 may also take the form of the binding mechanism shown in U.S. Pat. No. 7,717,638, the entire contents of which are hereby incorporated by reference.

It should be further understood that the bound component 10 need not necessarily include a binding mechanism 22 at all. In addition, the bound component 10 need not necessarily include a spine, in which case the covers 14, 16 can be directly pivotally coupled to each other. The bound component 10 can thus take the form of a binder, notebook, folder, folio, pocket, pocket divider, planner and the like. One or more pockets (not shown) may be provided on the inner and/or outer surfaces of the outer casing 12.

The outer casing 12 may be made of a generally flat, planar material, with sufficient stiffness to retain its shape when the bound component 10 is stood upright/on end. The outer casing 12 can be made of a variety of materials including plastics or polymers materials, including PVC, polypropylene, polyethylene, polyethylene vinyl acetate (PEVA), easy-processing polyethylene (EPPE), or other materials such as fabric, leather, cardboard or paper, polymer-covered cardboard or paper, etc. In the embodiment of FIGS. 1-4, the front 14 and back 16 covers are generally rectangular each include an inwardly-extending gusset 17 extending around three sides of the associated cover 14, 16. The gussets 17 can be releasably attachable together along their three sides by a closure mechanism, such as a zipper assembly 27, to thereby releasably attach the front 14 and back 16 covers. However, the front 14 and back 16 covers can be releasably attached by a variety of other mechanisms besides zippers, and in any case need not necessarily be attachable together.

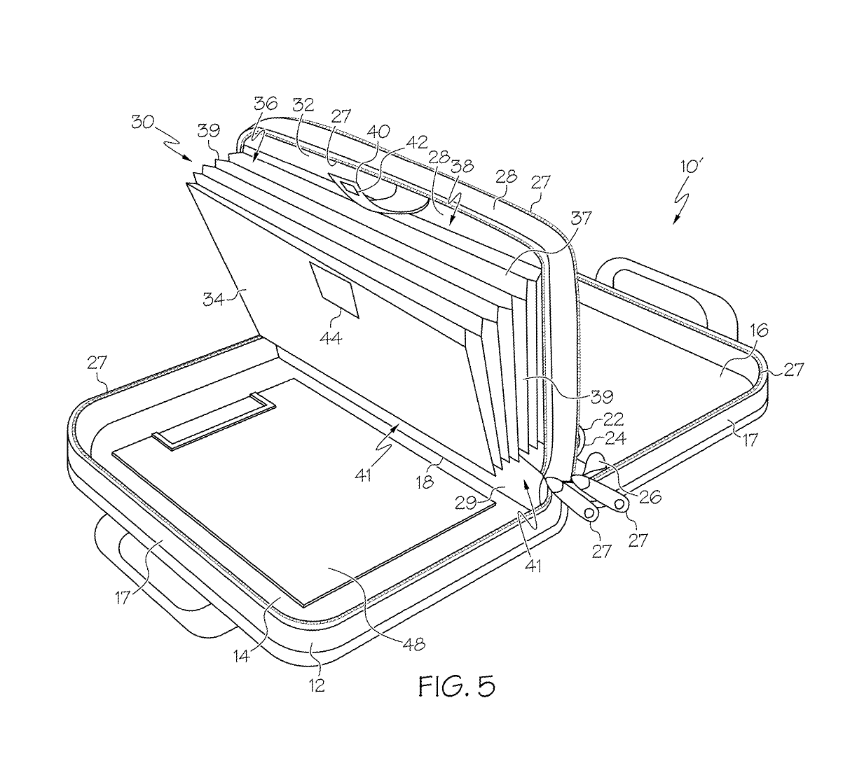

The bound component 10 can include a pocket panel 28 that is pivotally coupled to the outer casing 12. The pocket panel 28 can be generally rectangular and generally the same size and/or shape as the front cover 14 and/or back cover 16. In the embodiment of FIGS. 1-4 the pocket panel 28 is at least slightly smaller than the front 14 and/or back covers 16 to enable the pocket panel 28 to be fully captured therebetween and protected, such as when the bound component 10 is closed and the front 14 and back 16 covers are secured together as shown in FIG. 1. In an alternative embodiment as shown in FIG. 5, the bound component 10′ has a pocket panel 28 that is the same or about the same size and shape as the front 14 and back 16 covers such that the pocket panel 28 can be individually releasably secured to the front 14 and back 16 covers about their outer perimeters, via two separate pocket panel fastener assemblies 27.

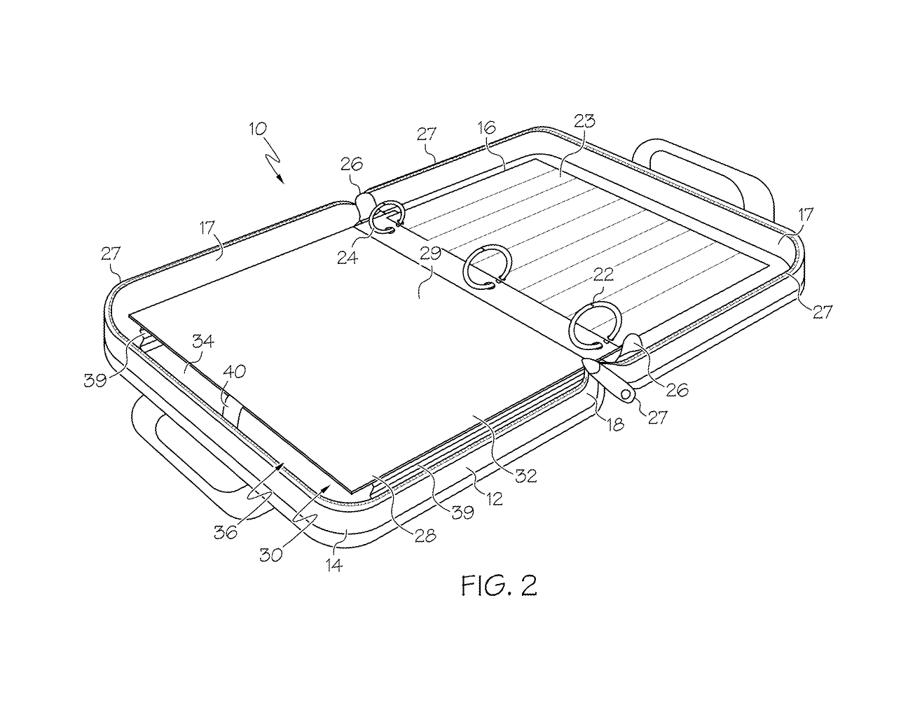

The pocket panel 28 can be directly pivotally mounted to the hinge/spine 18 as shown in FIGS. 2-5, but could instead be pivotally mounted to the front cover 14 or back cover 16. In the illustrated embodiment the pocket panel 28 is not bound to the binding mechanism 22, leaving the binding mechanism 22 free to bind other components thereto, such as a piece of paper 23 as shown in FIG. 2. Moreover, in the illustrated embodiment the binding mechanism 22 is not directly coupled to or directly carried on the pocket panel 28, and is instead spaced apart from the pocket panel 28, such that any pivotable movement of the pocket panel 28 does not cause corresponding pivotable movement of or otherwise move the binding mechanism 22.

A pocket 30 can be positioned on one side of the pocket panel 28. In one embodiment the pocket 30 takes the form of a generally rectangular prism and includes a back panel 32, which can be defined by and/or include part of the pocket panel 28 in one case. The pocket 30 can include a front panel 34 spaced away from and generally parallel with the back panel 32, defining a pocket cavity 36 therebetween, with a mouth 38 providing access to the pocket cavity 36. The pocket cavity 36 can have dividers 37 or the like positioned therein, dividing the pocket cavity 36 into multiple smaller cavities. The pocket panel 28 is thus pivotally coupled along an edge of the pocket panel 28 opposite the mouth 38.

The pocket 30 can further include two parallel side panels 39 positioned on opposite sides thereof and a bottom panel 41 positioned perpendicular to the side panels 39 and extending from one side panel 39 to the other. The bottom panel 41 and/or each of the side panels 39 can be made of an expandable/collapsible material, such as an accordion-style material in one case. In the illustrated embodiment the pocket 30 is smaller than pocket panel 28 in front/plan view. This arrangement allows a bottom portion of the pocket panel 28 to be pivotally coupled to the outer cover 12 and enables free pivotal motion thereof, and can allow lateral movement/expansion of the pocket 30.

The outer casing 12 is positionable in a flat, laid-open configuration, wherein the front 14 and back 16 covers are generally parallel, adjacent to each other and co-planar, and do not overlap in a thickness direction of the bound component 10, 10′ as shown in FIGS. 2-5. The outer casing 12 is also positionable in a closed position wherein the front 14 and back 16 covers are generally parallel and aligned and overlap in a thickness direction of the outer casing 12. When the outer casing 12 is in the closed position the pocket panel 28 and/or pocket 30 can be trapped or positioned therebetween, positioned entirely internally in or relative to the outer casing 12, as shown in FIG. 1. In the embodiment of FIGS. 1-4 the pocket panel 28, back panel 32, side panels 39 and bottom panel 41 are all entirely positionable between the front 14 and back 16 covers, internally to the outer casing. In the embodiment of FIG. 5, the pocket 30 is still positionable internally to the outer casing 12.

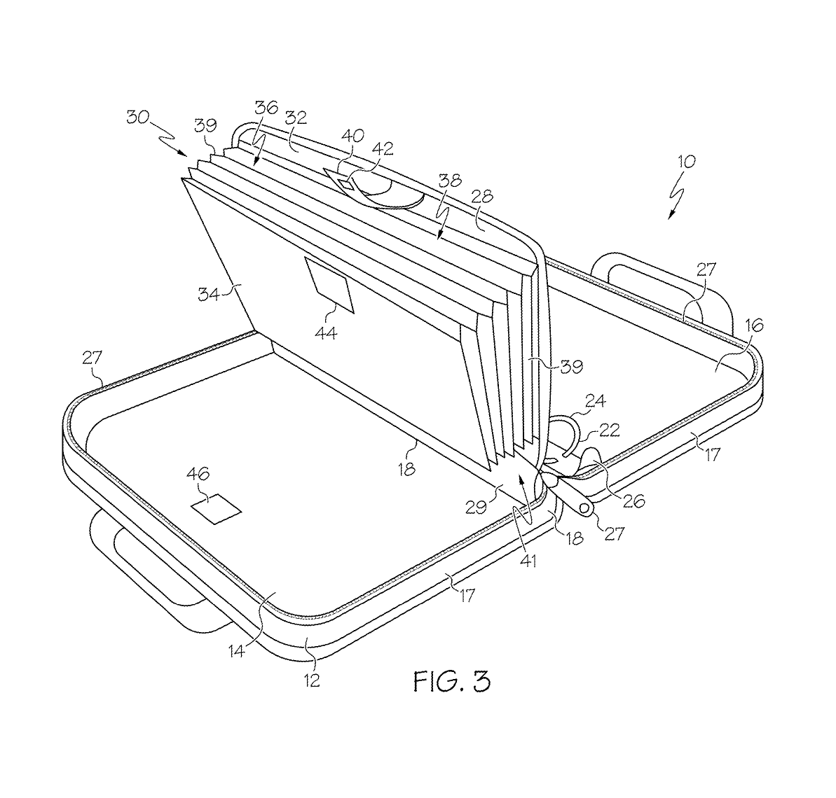

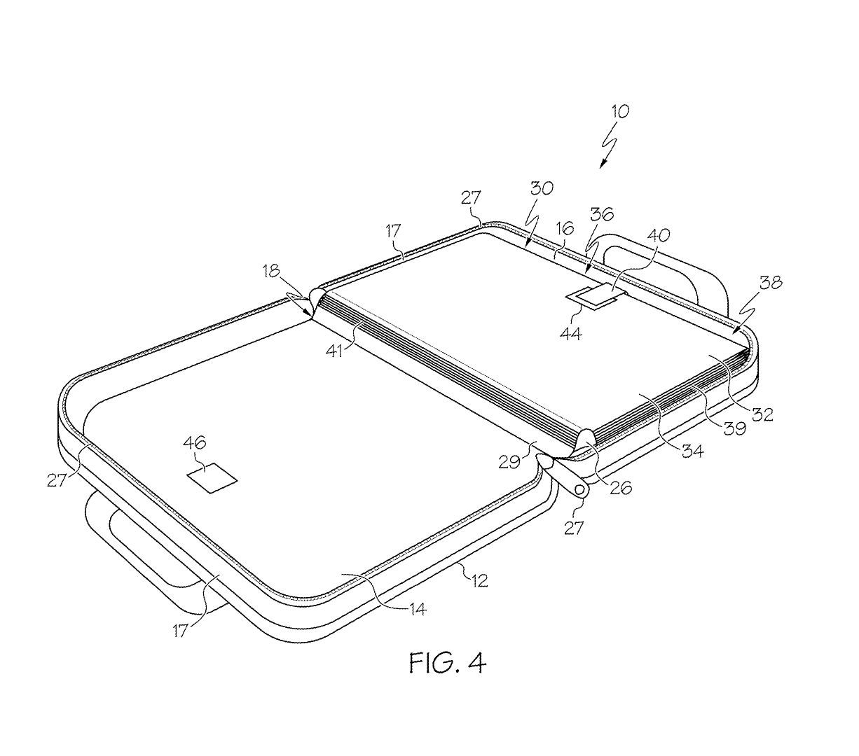

The pocket panel 28, or at least a portion of the pocket panel 28 and/or outer casing 12 adjacent to the inner edge of the pocket panel 28, shown as portion 29, can be made of sufficiently flexible material to enable the pocket panel 28 to pivot. FIG. 2 illustrates the pocket panel 28 positioned against and parallel with the front cover 14, FIG. 3 illustrates the pocket panel 28 in a vertical position, perpendicular to the front 14 and back covers 16, and FIG. 4 illustrates the pocket panel 28 positioned against and parallel with the back cover 16. In the configuration of FIG. 2, the pocket 30 is positioned between the pocket panel 28 and the front cover 14, and in the configuration of FIG. 4 the pocket panel 28 is positioned between the pocket 30 and the back cover 16. The pocket 30/pocket panel 28 is thus pivotable at least about 150 degrees, in one case or at least about 180 degrees in another case, when said outer casing 12 is in the laid-open configuration.

The flexible nature of inner portion 29 of pocket panel 28 can enable this pivoting motion. However, various other arrangements can be provided to enable the pivoting motion of the pocket panel 28, such as by a hinge mounting or the like. However, the flexible nature of the inner portion 29 also enables the pocket 28 to fold over/conform to the binder rings 22 when the pocket panel 28 is folded over the binder rings 22, as shown in FIG. 4. Thus the inner portion 29/pocket panel 28 may have sufficient flexibility to not be self-supporting when arranged or held in a cantilever mounting arrangement, and instead a distal end of the pocket panel 28 may hang down at least about a 45 degree angle in one case, or at least about an 80 or at a 90 degree angle in another case, when the pocket panel 28 is arranged in a cantilever mounting arrangement, held or secured at its inner end adjacent the inner portion 29.

The bound component 10 can include a closure strap or pocket strap 40 permanently coupled to the pocket panel 28 and releasably attachable to the front panel 34 of the pocket 30. In this manner, when the closure strap 40 is closed (i.e. secured to the front panel 34) the mouth 38 of the pocket 30 is at least partially covered/closed to retain components in the pocket 30. In the illustrated embodiment the closure strap 40 includes a patch 42 of hook-and-loop fastening material, such as VELCRO® material, that is configured to releasably engage a corresponding patch 44 of hook-and-loop fastening material on the front panel 34/pocket 30. However, the position of the strap 40 can of course be reversed such that the strap 40 is permanently coupled to the pocket 30 and configured to be releasably secured to the pocket panel 28, or further alternatively, the strap 40 can be releasably coupled to both the pocket 30 and pocket panel 28. Moreover, any of a wide variety of other structures and devices can be utilized to secure the strap 40 in place, and any of a wide variety of other structures or device can used in place of the strap 40, including hooks, snaps, clasps, cords, ties, straps, inter-engaging features, magnets, etc.

The front cover 14 may optionally include a patch 46 of hook-and-loop fastening material configured to releasably engage the patch 44 of hook-and-loop fastening material of the pocket 30 to releasably secure the pocket 30 to the front cover 14. The patches 44, 46 may be sized larger than a distal end of the strap 40 such that the patches 44, 46 can releasably engage each other, even when the strap 40 engages the patch 44. When the strap 40 does not engage the patch 44, the patches 44, 46 of course can still engage each other. In this manner the patch 44 of hook-and-loop fastening material of the pocket 30 can serve the dual purpose of securing the front panel 34 to both the front cover 14 and the pocket panel 28 at the same or different times. Of course the various structures and devices described above, besides hook-and-loop fastening material, can be utilized. In addition, the back cover 16 can be releasably attachable to the pocket 30 in the same or an analogous manner.

Each panel 14, 16, 18, and the outer casing 12 as a whole, can be continuous or generally continuous, and more particularly can lack any openings or cut-outs formed therein, or any openings or cut-outs larger than the pocket 30 and/or pocket panel 28, or larger than about one square inch, or larger than the surface area of binding mechanism 22. The continuous or generally continuous nature of the outer casing 12 provides protection to the contents stored in the bound component 10. The outer casing 12 may also lack any openings or cut-outs positioned adjacent to the mouth 38 of the pocket 30, or that communicate with the mouth 38 of the pocket 30, to ensure contents of the pocket 30 remain secured therein.

The pocket panel 28/pocket 30 arrangement disclosed herein provides a pocket 30 that is pivotally mounted, yet does not take up any capacity of the binding mechanism 22. Moreover, while the pocket panel 28/pocket 30 is positionable adjacent to the front 14 and/or back cover 16, the pocket panel 28/pocket 30 is also positionable away from either or both of the front 14 and/or back covers 16, thereby exposing the inner surfaces thereof such that such inner surfaces can be beneficially utilized. For example, as shown in FIG. 5 a clipboard 48 or the like can be positioned on such inner surfaces of the front 14 and/or back covers 16.

Having described the invention in detail and by reference to the various embodiments, it should be understood that modifications and variations thereof are possible without departing from the scope of the invention.

What is claimed is:

1. A storage component comprising:
an outer casing including a first panel and a second panel pivotally coupled together;
a pocket panel directly pivotally coupled to said outer casing; and
a pocket positioned on said pocket panel, the pocket being pivotable relative to said outer casing and positionable internally to said outer casing.

2. The storage component of claim 1 further including a binding mechanism coupled to said outer casing, wherein said pocket panel is not bound to said binding mechanism.

3. The storage component of claim 2 wherein said binding mechanism is a ring binding mechanism positioned on an inner surface of said outer casing.

4. The storage component of claim 1 wherein when said outer casing is positionable in a laid flat open configuration wherein said first and second panels are generally parallel and co-planar, and wherein when said outer casing is in said laid flat open configuration the pocket panel is pivotable between a first position wherein the pocket panel is positioned adjacent to and generally parallel with said first panel, and a second position wherein said pocket panel is positioned adjacent to and generally parallel with said second panel.

5. The storage component of claim 4 wherein said storage component is configured such that when said pocket panel is in said first position said pocket is positioned between said pocket panel and said first panel, and when said pocket panel is in said second position said pocket panel is positioned between said pocket and said second panel.

6. The storage component of claim 1 wherein said pocket is entirely positionable internally to said outer casing.

7. The storage component of claim 1 wherein said outer casing is positionable in a closed position wherein the front and back panels are generally parallel and aligned and overlap in a thickness direction of the outer casing, and wherein an entirety of said pocket is positioned between said front and back panels when said outer casing is in said closed position.

8. The storage component of claim 1 wherein said pocket is at least partially defined by said pocket panel, and wherein said pocket further includes a front panel generally parallel to and spaced apart from said pocket panel, defining a cavity therebetween, wherein said front panel is pivotable relative to said outer casing via pivoting of said pocket panel relative to said outer casing.

9. The storage component of claim 1 wherein said pocket includes two parallel side panels positioned on opposite sides thereof and a bottom panel positioned generally perpendicular to said side panels and extending from one of said side panel to the other side panel, wherein each side panel and said bottom panel are made of an expandable material.

10. The storage component of claim 1 wherein said pocket in front view is smaller than said pocket panel in front view.

11. The storage component of claim 1 wherein said pocket panel is releasably attachable to said outer casing to prevent or limit pivoting motion of said pocket panel relative to said outer casing.

12. The storage component of claim 1 further including a pocket strap permanently coupled to one of said pocket or said pocket panel and releasably attachable to the other one of said pocket or said pocket panel, wherein said pocket strap is configured to span a mouth of said pocket when said pocket strap is releasably attached to the other one of said pocket or said pocket panel.

13. The storage component of claim 1 further including a pocket strap coupled or coupleable to said pocket panel and having a first piece of hook-and-loop fastening material, and wherein said pocket includes a second piece of hook-and-loop fastening material that is releasably engagable with said first piece of hook-and-loop fastening material to releasably couple said pocket strap and said pocket, wherein the storage component further includes a third piece of hook-and-loop fastening material positioned on said first panel, wherein said third piece of hook-and-loop fastening material is releasably engageable with said second piece of hook-and-loop fastening material to prevent or limit pivoting motion of said pocket panel relative to said outer casing.

14. The storage component of claim 1 wherein said pocket panel is directly pivotally coupled to said outer casing.

15. The storage component of claim 1 wherein said outer casing includes a third panel positioned between said first and second panels, and wherein said first panel is pivotally coupled to said third panel along one side thereof and said second panel is pivotally coupled to said third panel along another, opposite side thereof, and wherein said pocket panel is directly coupled to said third panel.

16. The storage component of claim 1 wherein said pocket panel has a generally flexible portion at or adjacent to where said pocket panel is coupled to said outer casing, wherein said flexible portion is sufficiently flexible to enable to said pocket panel to pivot relative to said outer casing.

17. The storage component of claim 1 wherein said first and second panels are each continuous and lack any openings formed therethrough.

18. The storage component of claim 1 wherein said binding mechanism is spaced away from and not directly coupled to said pocket panel.

19. A storage component comprising:
a generally continuous outer casing including a first panel and a second panel pivotally coupled together;
a binding mechanism coupled to said outer casing and positioned on an inner surface thereof; and
a pocket panel directly pivotally coupled to an inner surface of said outer casing, said pocket panel including or at least partially defining a pocket that is pivotable relative to said outer casing, and wherein said pocket panel is not bound to said binding mechanism.
